(19) United States
(12) Patent Application Publication
(10) Pub. No.: US 2019/0095834 A1
(43) Pub. Date: Mar. 28, 2019

(54) MATERIAL SUPPLY SUPPORT APPARATUS AND MATERIAL SUPPLY SUPPORT METHOD

(71) Applicant: Panasonic Intellectual Property Management Co., Ltd., Osaka (JP)

(72) Inventor: ATSUSHI NAKAZONO, Kanagawa (JP)

(21) Appl. No.: 16/134,951

(22) Filed: Sep. 18, 2018

(30) Foreign Application Priority Data
Sep. 25, 2017 (JP) 2017-183138

(51) Int. Cl. G06Q 10/06

(52) U.S. Cl. CPC G06Q 10/06312

(57) ABSTRACT

A material supply support apparatus includes an information acquisition unit, a delivering instruction creator, and a delivering instruction transmission unit. The information acquisition unit acquires production planning information, storage material information, transfer means information, and worker information. The delivering instruction creator creates a delivering instruction for picking up a material to be supplied to the manufacturing facility from a material storage cabinet and placing the material on the transfer means based on the production planning information, the storage material information, the transfer means information, and the worker information which are acquired by the information acquisition unit. The delivering instruction transmission unit transmits the delivering instruction to the delivering worker.

### BACKGROUND

### 1. Technical Field

The present disclosure relates to a material supply support apparatus and a material supply support method for supporting supply of a material to a manufacturing facility using transfer means.

### 2. Description of the Related Art

As a manufacturing facility for manufacturing a product, there is a component mounting machine that manufactures a mounting board on which components are mounted on a board. In the component mounting machine, component mounting work is executed in which a component supplied from a component supplier is sucked by a suction nozzle to be picked up and the component is mounted on the board. A component supply device such as a tape feeder for supplying the component is mounted on the component supplier. In a course of repeatedly executing the component mounting work, when the remaining number of components stored in the component supply device is less than a predetermined number, supply work of the component is performed by a worker (for example, see Japanese Patent Unexamined Publication No. 2016-115739 (PTL 1)). A management apparatus disclosed in PTL 1 supports a series of component supply work of picking up a supply component from a component storage cabinet that stores components, transporting the component to the component mounting machine, and supplying the component to the component supply device. Therefore, the management apparatus transmits information indicating a work sequence in which the worker can efficiently perform component supply work to the worker.

### SUMMARY

According to an aspect of the present disclosure, there is provided a material supply support apparatus including an information acquisition unit, a delivering instruction creator, and a delivering instruction transmission unit.

The information acquisition unit acquires production planning information, storage material information, transfer means information, and worker information.

The production planning information includes a scheduled usage number of a plurality of materials to be used in a manufacturing facility.

The storage material information includes the number of the materials stored in a material storage cabinet.

The transfer means information includes information for specifying transfer means for placing the materials and transporting the materials to the manufacturing facility.

The worker information includes information for specifying a delivering worker who executes delivering work for which the materials are picked up from the material storage cabinet and placed on the transfer means.

The delivering instruction creator creates a delivering instruction for picking up the materials to be supplied to the manufacturing facility from the material storage cabinet and placing the materials on the transfer means based on the production planning information, the storage material information, the transfer means information, and the worker information which are acquired by the information acquisition unit.

The delivering instruction transmission unit transmits the delivering instruction to the delivering worker.

According to another aspect of the present disclosure, there is provided a material supply support method including acquiring production planning information including a scheduled usage number of a plurality of materials to be used in a manufacturing facility, storage material information including the number of the materials stored in a material storage cabinet, transfer means information including information for specifying transfer means for placing the materials and transporting the materials to the manufacturing facility, and worker information including information for specifying a delivering worker who executes delivering work for which the materials are picked up from the material storage cabinet and placed on the transfer means; creating a delivering instruction for picking up the materials to be supplied to the manufacturing facility from the material storage cabinet and placing the materials on the transfer means based on the production planning information, the storage material information, the transfer means information, and the worker information; and transmitting the delivering instruction to the delivering worker.

### BRIEF DESCRIPTION OF THE DRAWINGS

FIG. 1 is an explanatory view of a configuration of a manufacturing system of an embodiment;

FIG. 2 is an explanatory view of a configuration of a component mounting line included in the manufacturing system of the embodiment;

FIG. 3 is an explanatory view of a configuration of an unmanned transport vehicle included in the manufacturing system of the embodiment;

FIG. 4 is a block diagram illustrating a configuration of a management computer included in the manufacturing system of the embodiment;

FIG. 5 is an explanatory view of an example of transfer means information used in the manufacturing system of the embodiment;

FIG. 6 is an explanatory view of an example of a delivering instruction used in the manufacturing system of the embodiment;

FIG. 7 is an explanatory view of an example of a supply instruction used in the manufacturing system of the embodiment;

FIG. 8 is an explanatory view of an example of conveyance instruction used in the manufacturing system of the embodiment;

FIG. 9 is an explanatory view of an example of a priority work instruction used in the manufacturing system of the embodiment;

FIG. 10 is an explanatory view of an example of an expected time table used in the manufacturing system of the embodiment;

FIG. 11 is an explanatory view of an example of delay information used in the manufacturing system of the embodiment;

FIG. 12 is a diagram illustrating a flow of a material supply support method of an embodiment; and

FIG. 13 is a diagram illustrating a flow of another embodiment of a material supply support method of an embodiment.

### DETAILED DESCRIPTIONS

In the related art disclosed in PTL 1 or the like, one worker reciprocates between the component storage cabinet and the component mounting machine to supply the component. Therefore, in a case where a large amount of components are supplied, work efficiency may decrease and there is still room for further improvement.

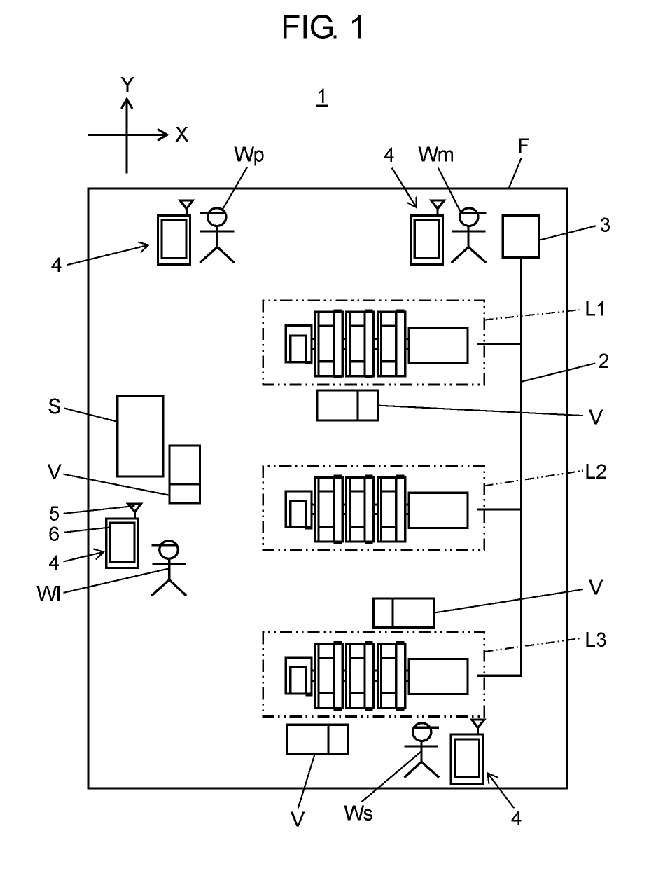

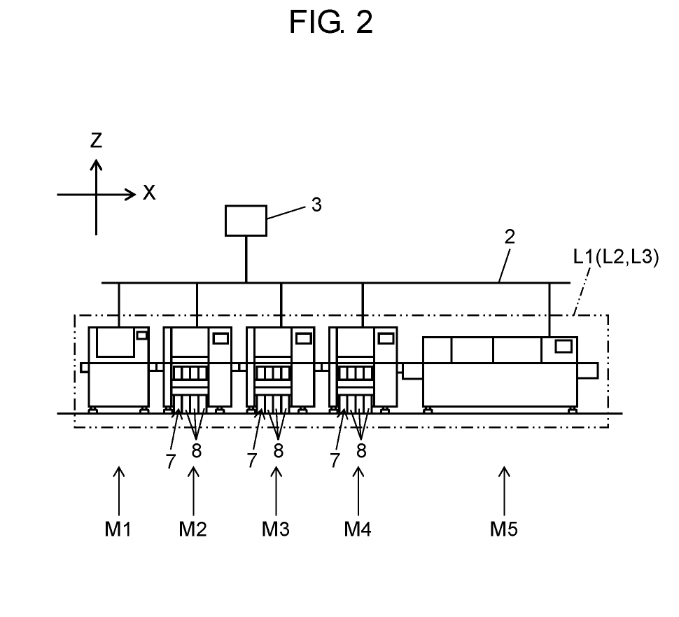

Hereinafter, embodiments will be described in detail with reference to the drawings. Configurations, shapes, and the like described below are examples for explanation, and can be appropriately changed in accordance with the specifications of a manufacturing system and a component mounting line. In the following description, the same reference numerals are given to corresponding elements in all drawings and redundant explanations will be omitted. In FIG. 1 and in a part to be described later, as two axial directions orthogonal to each other in a horizontal plane, an X direction (rightward and leftward direction in FIG. 1) indicates a board transport direction and a Y direction (upward and downward direction in FIG. 1) indicates a direction orthogonal to the board transport direction. In FIG. 2, a Z direction (upward and downward direction in FIG. 2) indicates a height direction orthogonal to the horizontal plane.

First, a configuration of manufacturing system 1 will be described with reference to FIG. 1. Manufacturing system 1 has a configuration in which three component mounting lines L1 to L3 disposed on floor F are connected by communication network 2, which is wired or wireless, and managed by management computer 3 (material supply support apparatus). As described below, each of component mounting lines L1 to L3 is formed by connecting a plurality of manufacturing facilities including a component mounting machine, and has a function of manufacturing a mounting board where a component is mounted on a board. The component mounting line included in manufacturing system 1 is not limited to three and may be one, two, or four or more.

Material storage cabinet S is disposed on floor F. A plurality of materials which are supplied and used in the manufacturing facility configuring component mounting lines L1 to L3 are stored in material storage cabinet S. Hereinafter, it is assumed that a component as a material is stored in a component reel in material storage cabinet S.

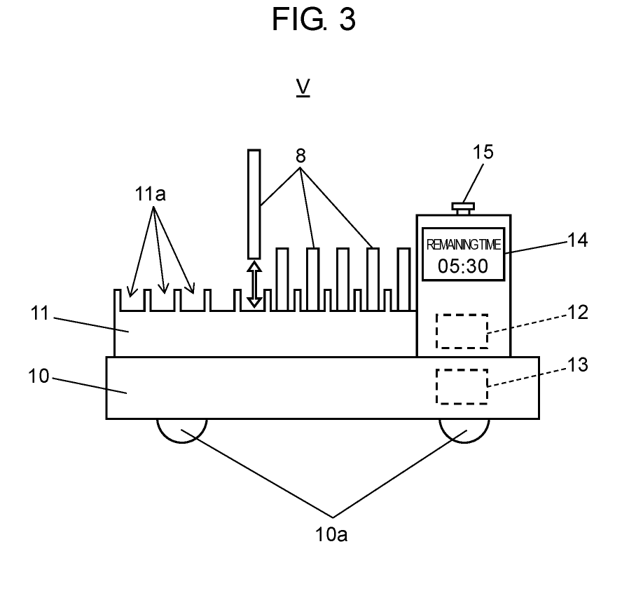

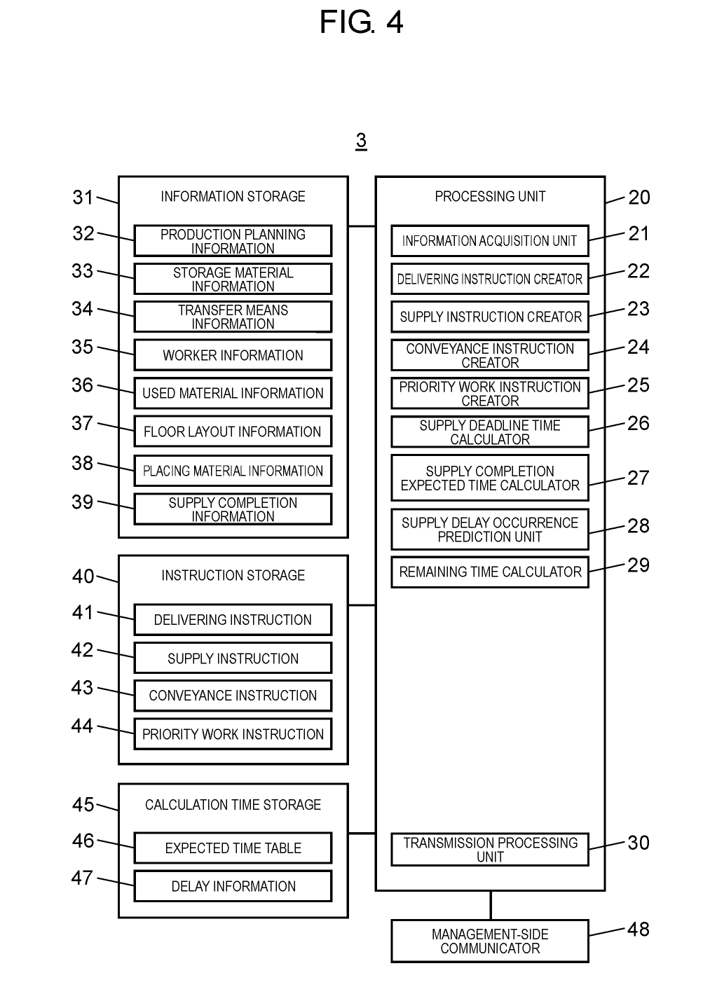

In FIG. 1, a plurality of unmanned transport vehicles V are disposed on floor F. Unmanned transport vehicle V has wireless communicator 13 (see FIG. 3). Unmanned transport vehicle V transmits and receives a signal and information to and from management computer 3 via management-side communicator 48 (see FIG. 4) included in management computer 3. Unmanned transport vehicle V autonomously moves on a traveling route set in floor F based on conveyance instruction 43 (see FIG. 4) transmitted from management computer 3 and information to be collected by itself. Here, the information to be collected by itself is information collected by unmanned transport vehicle V by a traveling route tape and beacons (not illustrated) disposed on floor F, various sensors (obstacle sensor and the like) built in unmanned transport vehicle V, a Global Positioning System (GPS), a camera, and the like.

Delivering worker Wl, supply worker Ws, priority worker Wp, and administrator Wm are working on floor F. Delivering worker Wl executes delivering work for which a material is picked up from material storage cabinet S and is placed on unmanned transport vehicle V (transfer means). Supply worker Ws executes supply work for picking up the material from unmanned transport vehicle V and supplying the material to the manufacturing facility (component mounting machine). Priority worker Wp executes priority work for which a material of which supply delay is predicted from material storage cabinet S or unmanned transport vehicle V is picked up and is supplied to the manufacturing facility with priority. Administrator Wm manages the manufacture of the mounting board in manufacturing system 1, for example, instructing recovery work or the like in a case where the supply delay is predicted.

The number and disposition of workers are appropriately changed in accordance with the configurations of floor F and manufacturing system 1, a type of the mounting board to be manufactured, and the like. When priority worker Wp is not required to be a full-time worker and the supply delay is predicted, delivering worker W1 or supply worker Ws with sufficient margin may be designated.

In FIG. 1, each worker carries mobile terminal 4. Mobile terminal 4 includes terminal-side communicator 5 that wirelessly communicates with management computer 3 to exchange information and touch panel 6 having a display function and an input function. Mobile terminal 4 displays various kinds of information received from management computer 3 and displays them on touch panel 6. Mobile terminal 4 transmits various kinks of information or the like input from touch panel 6 to management computer 3.

Next, a detailed configuration of component mounting lines L1 to L3 will be described with reference to FIG. 2. Component mounting lines L1 to L3 have the same configuration and hereinafter, component mounting line L1 will be described. Component mounting line L1 has printing machine M1, component mounting machine M2, component mounting machine M3, component mounting machine M4, and reflow apparatus M5, which are manufacturing facilities, in order from an upstream side (left side in FIG. 2) in the board transport direction. Each manufacturing facility has a board transport mechanism such as a belt conveyor and manufactures the mounting board while transporting the board from the upstream to the downstream by the board transport mechanism of each manufacturing facility. Each manufacturing facility is connected to management computer 3 by wired or wireless communication network 2 and can transmit and receive data to and from management computer 3.

In FIG. 2, printing machine M1 has a function of printing paste-like cream solder on the board via a screen mask. A remaining amount of the cream solder as a material is transmitted to management computer 3 as used material information 36 (see FIG. 4) at a predetermined timing. When the remaining amount of the cream solder is a predetermined amount or less, the supply work is executed by supply worker Ws. Three component mounting machines M2 to M4 have a function of picking up the component supplied from component supplier 7 by a component suction nozzle which is mounted on a mounting head, and transporting and placing the board on which the cream solder is printed to a mounting point of the board.

A plurality of component supply units and a plurality of component reels 8 for supplying the component are mounted on each component supplier 7 of component mounting machines M2 to M4. A carrier tape for storing the component is wound and stored in component reel 8. The carrier tape stored in component reel 8 is supplied to the component supply unit. The remaining number of the components is transmitted to management computer 3 as used material information 36 at a predetermined timing. When the remaining number (remaining amount) of the components which are the materials is less than a predetermined amount, the supply work is executed to join and supply the carrier tape for supplying the component which is stored by component reel 8 at a rear end of the carrier tape supplied to the component supply unit by supply worker Ws.

Reflow apparatus M5 has a function of heating the board on which the component is placed, melting the cream solder, and then solidifying the cream solder to solder the component to the board. Management computer 3 executes production management of the mounting board manufactured in component mounting lines L1 to L3, a process such as downloading of a program and data necessary for manufacturing the mounting board for each manufacturing facility, a process of supporting the supply work for supplying the material to the manufacturing facility, and the like.

Next, a configuration of unmanned transport vehicle V will be described with reference to FIG. 3. Unmanned transport vehicle V is configured to have reel storage unit 11 on an upper portion of carriage unit 10 having a motor for driving vehicle wheel 10a and vehicle wheel 10a. Reel storage unit 11 is formed of a plurality of storage slots 11a for storing component reels 8. Each of storage slots 11a is assigned a slot number. Unmanned transport vehicle V includes control device 12, wireless communicator 13, remaining time display unit 14, and button 15. Wireless communicator 13 wirelessly communicates with management computer 3. Control device 12 includes a storage that stores conveyance instruction 43, a delivering work remaining time, a supply work remaining time, or the like acquired from management computer 3, and a movement controller that controls the movement of unmanned transport vehicle V based on conveyance instruction 43 or the like.

Remaining time display unit 14 displays a predetermined remaining time such as the delivering work remaining time until a scheduled completion time of the delivering work or the supply work remaining time until a scheduled completion time of the supply work. Button 15 is operated by delivering worker Wl or supply worker Ws when the delivering work or the supply work is completed. When button 15 is operated, the effect is transmitted to control device 12 and is transferred to management computer 3.

Instructed component reel 8 is picked up from material storage cabinet S by delivering worker Wl to be placed on reel storage unit 11 of unmanned transport vehicle V. When the placement of component reel 8 is completed and button 15 is operated by delivering worker Wl, unmanned transport vehicle V starts to move toward the manufacturing facility based on conveyance instruction 43. That is, unmanned transport vehicle V is transfer means for placing the material (component stored in component reel 8) and transporting the material to the manufacturing facilities (component mounting machines M2 to M4). When unmanned transport vehicle V arrives at the instructed manufacturing facility and stops, the instructed material is picked up by supply worker Ws to be supplied to the manufacturing facility.

Next, a configuration of management computer 3 will be described with reference to FIG. 4. Management computer 3 includes processing unit 20, information storage 31 that is a storage device, instruction storage 40, calculation time storage 45, and management-side communicator 48. Processing unit 20 is a data processing device such as a Central Processing Unit (CPU) and includes information acquisition unit 21, delivering instruction creator 22, supply instruction creator 23, conveyance instruction creator 24, priority work instruction creator 25, supply deadline time calculator 26, supply completion expected time calculator 27, supply delay occurrence prediction unit 28, remaining time calculator 29, and transmission processing unit 30 as internal processing units. Management-side communicator 48 wirelessly communicates with mobile terminal 4 and unmanned transport vehicle V to perform exchange of information.

In FIG. 4, information acquisition unit 21 acquires production planning information 32, storage material information 33, transfer means information 34, worker information 35, used material information 36, floor layout information 37, placing material information 38, supply completion information 39 from a database, the manufacturing facility, mobile terminal 4, unmanned transport vehicle V, or the like to store them in information storage 31. Production planning information 32 includes the number of production of the mounting boards manufactured by manufacturing system 1, scheduled production completion date and time, information (component number, reel number, or the like) for specifying a plurality of the materials used in the manufacturing facility, and the number of scheduled uses of the material. Storage material information 33 includes information for specifying the material stored in material storage cabinet S, the number of stored materials, and a stored position (shelf number, or the like).

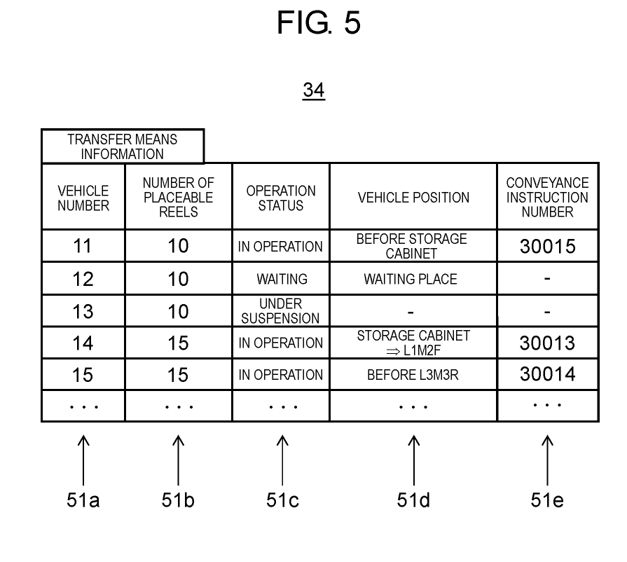

Here, an example of transfer means information 34 will be described with reference to FIG. 5. Transfer means information 34 includes vehicle number 51a, number of placeable reels 51b, operation status 51c, vehicle position 51d, and conveyance instruction number 51e. Vehicle number 51a is information for specifying unmanned transport vehicle V (transfer means). Number of placeable reels 51b is the number of component reels 8 capable of being placed on unmanned transport vehicle V. Operation status 51c indicates a current operation status of unmanned transport vehicle V. For example, “in operation” indicates a state where unmanned transport vehicle V is in operation upon receiving conveyance instruction 43. “Waiting” indicates a state where unmanned transport vehicle V is in operation, but is waiting for conveyance instruction 43. “Under suspension” indicates a state where unmanned transport vehicle V is not in operation due to charging, maintenance, or the like.

Vehicle position 51d indicates a current location of unmanned transport vehicle V. For example, “in front of storage cabinet” indicates that unmanned transport vehicle V is stopped in front of material storage cabinet S. “Waiting place” indicates that unmanned transport vehicle V is stopped at a waiting place waiting until receiving conveyance instruction 43. “Before L3M3R” includes that unmanned transport vehicle V is stopped before the manufacturing facility (in this example, a rear side of component mounting machine M3 of component mounting line L3). “Storage cabinet⇒L1M2F” indicates that unmanned transport vehicle V is in movement in the traveling route (in this example, from material storage cabinet S to a front side of component mounting machine M2 of component mounting line L1). Conveyance instruction number 51e is information for specifying conveyance instruction 43 instructed by unmanned transport vehicle V.

In FIG. 4, worker information 35 includes information for specifying delivering worker W1 executing the delivering work, information for specifying supply worker Ws executing the supply work, information for specifying priority worker Wp executing the priority work, and information for specifying administrator Wm. Used material information 36 includes the remaining amount (remaining amount of the cream solder, remaining number of the components, or the like) of the material used in the manufacturing facility, and information (facility number, supply position, or the like) for specifying the position at which the material is used.

Floor layout information 37 includes the disposition of the manufacturing facility on floor F, the disposition of material storage cabinet S, information of the traveling route of unmanned transport vehicle V (transfer means), and a moving speed of unmanned transport vehicle V. Placing material information 38 includes information (vehicle number) for specifying unmanned transport vehicle V on which the material is placed, information for specifying the material placed on unmanned transport vehicle V, and the position (slot number, or the like) to be placed. Supply completion information 39 includes information relating to the material of which the supply to the manufacturing facility is completed.

In FIG. 4, delivering instruction creator 22 determines assigned delivering worker Wl based on production planning information 32, storage material information 33, transfer means information 34, worker information 35, and floor layout information 37. Delivering instruction creator 22 creates delivering instruction 41 for placing the material supplied to the manufacturing facility by delivering worker Wl on unmanned transport vehicle V (transfer means) by picking up the material from material storage cabinet S. Created delivering instruction 41 is stored in instruction storage 40. Created delivering instruction 41 is information-processed by transmission processing unit 30 and is transmitted to mobile terminal 4 carried by delivering worker Wl via management-side communicator 48. Delivering instruction 41 received by mobile terminal 4 is displayed on touch panel 6. That is, transmission processing unit 30, management-side communicator 48, and mobile terminal 4 are delivering instruction transmission means (delivering instruction transmission unit) for transmitting delivering instruction 41 to delivering worker Wl.

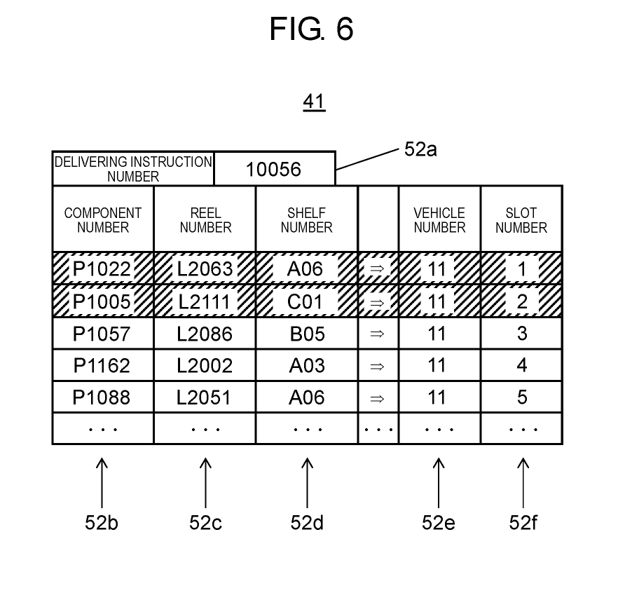

Here, an example of delivering instruction 41 will be described with reference to FIG. 6. Delivering instruction 41 is created by delivering instruction creator 22 for each delivering work executed by delivering worker Wl and delivering instruction number 52a that specifies a series of delivering work is given. Delivering instruction 41 includes information (component number 52b and reel number 52c) for specifying the material placed on unmanned transport vehicle V, a position (shelf number 52d) at which the material is stored in material storage cabinet S, information (vehicle number 52e) for specifying unmanned transport vehicle V which places the material, and a position (slot number 52f) of storage slot 11a which places the material.

Delivering instruction 41 is arranged in the order of executing the delivering work. In the example of FIG. 6, the instructions are arranged such that component reel 8 is stored in storage slot 11a in the order of picking up the material from unmanned transport vehicle V in the supply work. The instructions may be arranged in the order in which the materials are stored in material storage cabinet S. That is, delivering instruction creator 22 creates delivering instruction 41 including the order of picking up the material from material storage cabinet S and the order of placing the material on the transfer means. Delivering instruction creator 22 determines unmanned transport vehicle V (transfer means) which places the material from operation status 51c included in transfer means information 34.

Delivering worker Wl executes the delivering work according to delivering instruction 41 displayed on touch panel 6 of carried mobile terminal 4. When the delivering work is completed, delivering worker Wl operates touch panel 6 or operates button 15 of unmanned transport vehicle V to report the completion of the work. When the completion of the work is reported, the effect is transmitted to management computer 3. In FIG. 6, hatching with diagonal lines is applied to the instruction in which the work is completed.

In FIG. 4, supply instruction creator 23 determines assigned supply worker Ws based on transfer means information 34, placing material information 38, worker information 35, and floor layout information 37. Supply instruction creator 23 creates supply instruction 42 for supplying the material to be supplied to the manufacturing facility by supply worker Ws to the manufacturing facility by picking up the material from unmanned transport vehicle V (transfer means). Created supply instruction 42 is stored in instruction storage 40. Created supply instruction 42 is information-processed by transmission processing unit 30 and is transmitted to mobile terminal 4 carried by supply worker Ws via management-side communicator 48. Supply instruction 42 received by mobile terminal 4 is displayed on touch panel 6. That is, transmission processing unit 30, management-side communicator 48, and mobile terminal 4 become supply instruction transmitting means for transmitting supply instruction 42 to supply worker Ws.

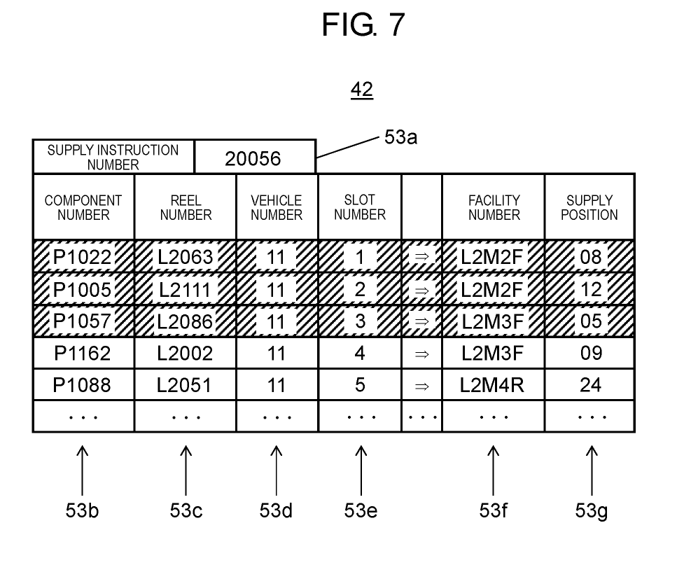

Here, an example of supply instruction 42 will be described with reference to FIG. 7. Supply instruction 42 is created by supply instruction creator 23 for each supply work executed by supply worker Ws and supply instruction number 53a that specifies a series of the supply work is given.

Supply instruction 42 includes information (component number 53b and reel number 53c) for specifying the material to be supplied to the manufacturing facility, information (vehicle number 53d) for specifying unmanned transport vehicle V which places the material, a position (slot number 53e) of storage slot 11a in which the material is placed, and information (facility number 53f and supply position 53g) for specifying the position to which the material is supplied.

Supply instruction 42 is arranged in the order of executing the supply work. In the example of FIG. 7, the instructions are arranged in the order of picking up the material from unmanned transport vehicle V in the supply work, that is, the order of slot number 53e. That is, supply instruction creator 23 creates supply instruction 42 including the order of supplying the material to the manufacturing facility.

Supply worker Ws executes the supply work according to supply instruction 42 displayed on touch panel 6 of carried mobile terminal 4. When the supply work is completed, supply worker Ws operates touch panel 6 or operates button 15 of unmanned transport vehicle V to report the completion of the work. When the completion of the work is reported, the effect is transmitted to management computer 3. In FIG. 7, hatching with diagonal lines is applied to the instruction in which the work is completed.

In FIG. 4, conveyance instruction creator 24 determines assigned unmanned transport vehicle V based on floor layout information 37, supply instruction 42, and an expected time included in expected time table 46 which is described later. Conveyance instruction creator 24 creates conveyance instruction 43 including the traveling route and the stop position of unmanned transport vehicle V (transfer means). Created conveyance instruction 43 is stored in instruction storage 40. Created conveyance instruction 43 is transmitted to instructed unmanned transport vehicle V via management-side communicator 48. Unmanned transport vehicle V which receives conveyance instruction 43 moves and stops according to conveyance instruction 43. That is, management-side communicator 48 is a conveyance instruction transmission unit that transmits conveyance instruction 43 to unmanned transport vehicle V (transfer means).

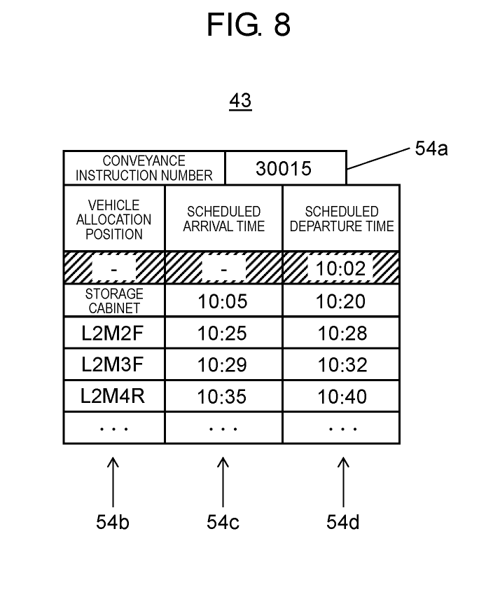

Here, an example of conveyance instruction 43 will be described with reference to FIG. 8. Conveyance instruction 43 is created by conveyance instruction creator 24 and conveyance instruction number 54a that specifies conveyance instruction 43 is given. Conveyance instruction 43 includes a position (vehicle allocation position 54b) at which unmanned transport vehicle V is stopped, scheduled arrival time 54c at which unmanned transport vehicle V arrives at vehicle allocation position 54b, and scheduled departure time 54d at which unmanned transport vehicle V departs to next vehicle allocation position 54b.

In the example, unmanned transport vehicle V departs from the waiting place to material storage cabinet S at “10:02” and the delivering work is completed, and then is instructed to stop in order of “L2M2F”, “L2M3F”, and “L2M4R” for the supply work. In FIG. 8, hatching with diagonal lines is applied to the instruction in which the work is completed.

In FIG. 4, supply deadline time calculator 26 calculates a supply deadline time that is a deadline for supplying the material to the manufacturing facility based on production planning information 32 and used material information 36. Supply completion expected time calculator 27 calculates a supply completion expected time at which the material to be supplied to the manufacturing facility by delivering worker Wl is picked up from material storage cabinet S, and is placed on unmanned transport vehicle V (transfer means), unmanned transport vehicle V on which the material is placed moves to the manufacturing facility of a supply target, the material is picked up by supply worker Ws from stopped unmanned transport vehicle V, and the supply work for supplying the material to the manufacturing facility is completed, based on production planning information 32, storage material information 33, transfer means information 34, worker information 35, used material information 36, and floor layout information 37.

The supply deadline time and the supply completion expected time which are calculated are stored in calculation time storage 45 as expected time table 46. Supply completion expected time calculator 27 also stores a delivering completion expected time, which is calculated as intermediate information and at which the delivering work for picking up the material from material storage cabinet S by delivering worker Wl and placing the material on unmanned transport vehicle V is completed, is stored in expected time table 46. Supply delay occurrence prediction unit 28 predicts the occurrence of the supply delay in which the supply completion expected time exceeds the supply deadline time.

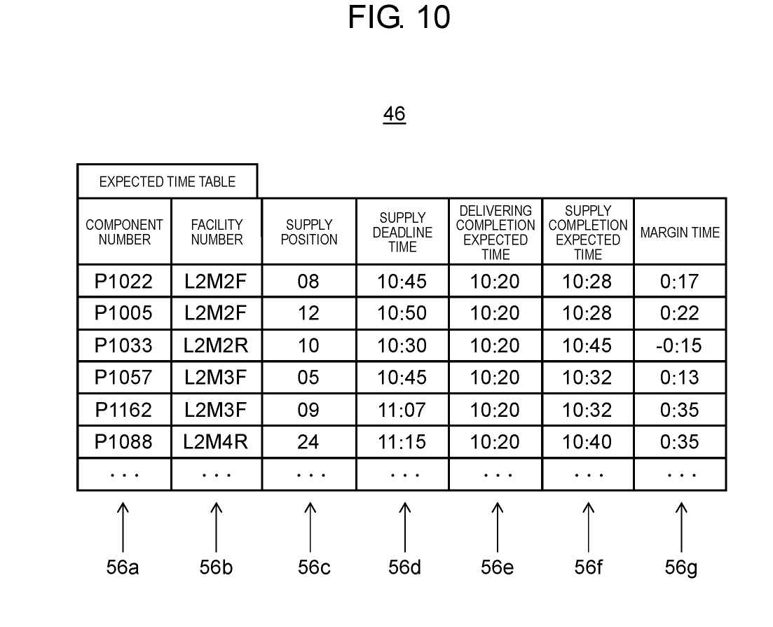

Here, an example of expected time table 46 will be described with reference to FIG. 10. Expected time table 46 includes information (component number 56a) for specifying the material used in (or to be used from) the manufacturing facility, information (facility number 56b and supply position 56c) for specifying the position at which the material is used, supply deadline time 56d, delivering completion expected time 56e, supply completion expected time 56f, and margin time 56g which is a difference between supply deadline time 56d and supply completion expected time 56f.

In FIG. 4, supply delay occurrence prediction unit 28 predicts the occurrence of the supply delay when supply completion expected time 56f is later than supply deadline time 56d and margin time 56g becomes negative (for example, component number 56a of FIG. 10 is a component of “P1033”). Otherwise, supply delay occurrence prediction unit 28 may predict the occurrence of the supply delay when margin time 56g is shorter than a predetermined time. When the occurrence of the supply delay is predicted, supply delay occurrence prediction unit 28 creates delay information 47 relating to the material for which the supply delay is predicted. Created delay information 47 is stored in calculation time storage 45.

Created delay information 47 is information-processed by transmission processing unit 30 and is transmitted to mobile terminal 4 carried by administrator Wm via management-side communicator 48. Delay information 47 received by mobile terminal 4 is displayed on touch panel 6. That is, transmission processing unit 30, management-side communicator 48, and mobile terminal 4 become delay information transmission means which transmits delay information 47 to administrator Wm. Administrator Wm looks delay information 47 displayed on mobile terminal 4 or the like to consider countermeasures to avoid the stop of the manufacturing facility due to the lack of the component by the execution of the priority work, addition of unmanned transport vehicle V, or the like.

In a case where administrator Wm uses management computer 3 to manage manufacturing of the mounting board in manufacturing system 1, delay information 47 may be displayed on a display device (not illustrated) included in management computer 3. In this case, transmission processing unit 30 and the display device of management computer 3 become the delay information transmission means.

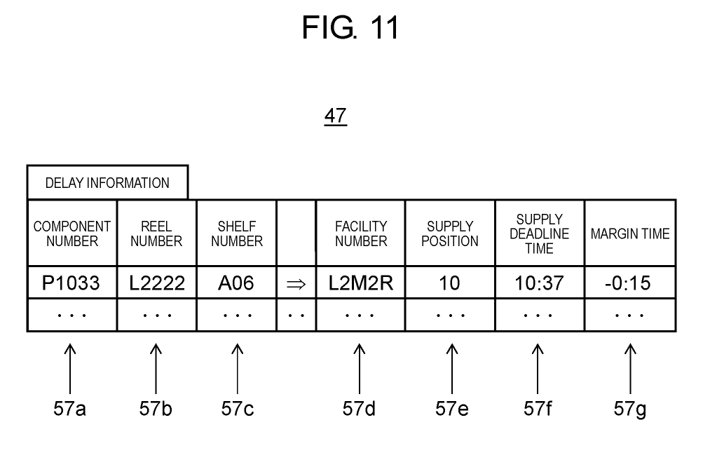

Here, an example of delay information 47 will be described with reference to FIG. 11. Delay information 47 includes information (component number 57a and reel number 57b) for specifying the material for which the delay is predicted, a position (shelf number 57c) at which the material is stored in material storage cabinet S, information (facility number 57d and supply position 57e) for specifying the position at which the material is used, supply deadline time 57f, and margin time 57g. In a case where the material for which the delay is predicted is already placed on unmanned transport vehicle V, instead of shelf number 57c, information (vehicle number and vehicle position) for specifying unmanned transport vehicle V on which the material is placed and the location thereof, and the position (slot number) of storage slot 11a in which the material is placed are stored in delay information 47.

In FIG. 4, priority work instruction creator 25 determines allocated priority worker Wp when supply delay occurrence prediction unit 28 predicts the occurrence of the supply delay. Priority work instruction creator 25 creates priority work instruction 44 for executing the priority work for which the material, for which the supply delay is predicted, is picked up from material storage cabinet S or unmanned transport vehicle V (transfer means) by priority worker Wp, and is supplied to the manufacturing facility with priority. Created priority work instruction 44 is stored in instruction storage 40. Priority work instruction creator 25 automatically creates priority work instruction 44 when the occurrence of the supply delay is predicted, but may create priority work instruction 44 when administrator Wm instructs to create priority work instruction 44.

Created priority work instruction 44 is information-processed by transmission processing unit 30 and is transmitted to mobile terminal 4 carried by priority worker Wp via management-side communicator 48. Priority work instruction 44 received by mobile terminal 4 is displayed on touch panel 6. That is, transmission processing unit 30, management-side communicator 48, and mobile terminal 4 become priority work instruction transmission means for transmitting priority work instruction 44 to priority worker Wp executing the priority work.

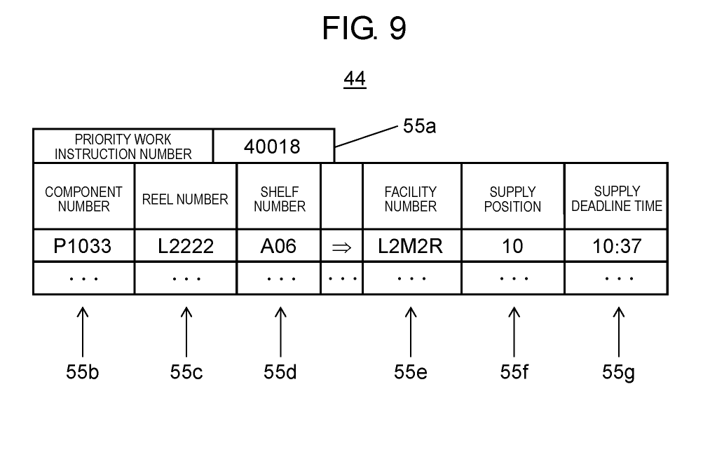

Here, an example of priority work instruction 44 will be described with reference to FIG. 9. Priority work instruction 44 is created by priority work instruction creator 25 for each priority work executed by priority worker Wp and priority work instruction number 55a that specifies a series of the priority work is given. Priority work instruction 44 includes information (component number 55b and reel number 55c) for specifying the material to be a target of the priority work, a position (shelf number 55d) at which the material is stored in material storage cabinet S, information (facility number 55e and supply position 55f) for specifying the position to which the material is supplied, and supply deadline time 55g.

In a case where the material to be the target of the priority work is already placed on unmanned transport vehicle V, instead of shelf number 55d, information (vehicle number and vehicle position) for specifying unmanned transport vehicle V on which the material is placed and the location thereof, and the position (slot number) of storage slot 11a in which the material is placed are stored in priority work instruction 44. That is, priority work instruction 44 includes information for specifying the location of the material supplied by the priority work.

In FIG. 4, when the priority work instructed by priority work instruction 44 is completed, priority worker Wp reports the completion of the priority work by an operation of touch panel 6 of mobile terminal 4, an operation of an input unit (not illustrated) of the manufacturing facility, or the like. Information acquisition unit 21 acquires the report of the priority work and stores the report in supply completion information 39. When transfer means information 34, used material information 36, and supply completion information 39 acquired by information acquisition unit 21 are updated, supply deadline time calculator 26 recalculates the supply deadline time and supply completion expected time calculator 27 recalculates the supply completion expected time. Furthermore, supply delay occurrence prediction unit 28 predicts again the occurrence of the supply delay based on the supply deadline time and the supply completion expected time which are recalculated. Therefore, the occurrence of the supply delay can be predicted based on the latest information.

In a case where the material that is instructed by priority work instruction 44 is stored in material storage cabinet S and the delivering work of the material is included in instructed delivering instruction 41, when the completion (or picking up of the instructed material from material storage cabinet 5) of the priority work is reported, delivering instruction creator 22 updates delivering instruction 41. The delivering instruction transmission means transmits updated delivering instruction 41 to delivering worker Wl.

In a case where the material that is instructed by priority work instruction 44 is placed on unmanned transport vehicle V, when the completion (or picking up of the instructed material from unmanned transport vehicle V) of the priority work is reported, supply instruction creator 23 updates supply instruction 42. The supply instruction transmitting means transmits updated supply instruction 42 to supply worker Ws. In this case, conveyance instruction creator 24 updates conveyance instruction 43. The conveyance instruction transmission unit transmits updated conveyance instruction 43 to unmanned transport vehicle V.

In FIG. 4, remaining time calculator 29 calculates the delivering work remaining time from a current time to the scheduled completion time (delivering completion expected time 56e of expected time table 46 illustrated in FIG. 10) of the delivering work. The calculated delivering work remaining time is transmitted to unmanned transport vehicle V in which the delivering work is performed via management-side communicator 48 and is displayed on remaining time display unit 14 of unmanned transport vehicle V. That is, remaining time calculator 29 and management-side communicator 48 become delivering work remaining time transmission means (delivering work remaining time transmission unit) which transmits information relating to the delivering work remaining time to remaining time display unit 14.

Remaining time calculator 29 calculates the supply work remaining time from the current time to the scheduled completion time (supply completion expected time 56f of expected time table 46 illustrated in FIG. 10) of the supply work. The supply work remaining time is a postponement time of the supply work executed from the stop of unmanned transport vehicle V for the supply work to the start thereof to move to the next stop position. The calculated supply work remaining time is transmitted to unmanned transport vehicle V in which the supply work is performed via management-side communicator 48 and is displayed on remaining time display unit 14 of unmanned transport vehicle V. That is, remaining time calculator 29 and management-side communicator 48 become supply work remaining time transmitting means for transmitting information relating to the supply work remaining time to remaining time display unit 14.

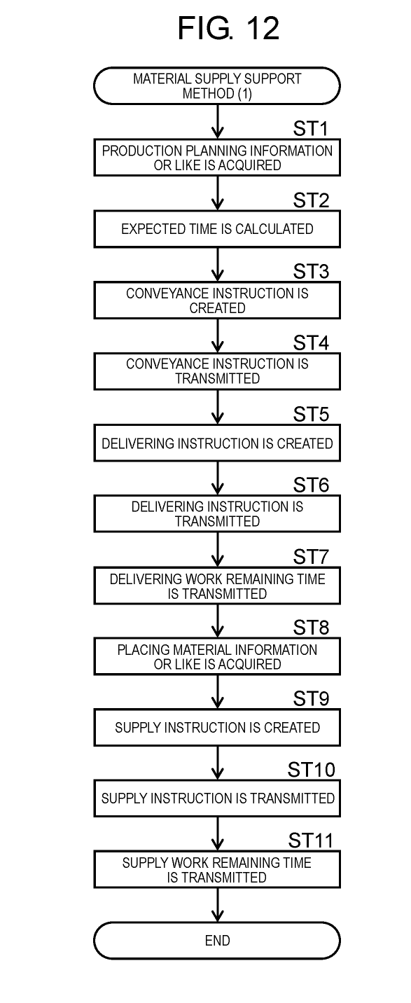

Next, a material supply support method for supporting the supply work for supplying the material used in the manufacturing facility to the manufacturing facility will be described with reference to a flow of FIG. 12. In the material supply, the material is conveyed by unmanned transport vehicle V. First, information acquisition unit 21 acquires production planning information 32, storage material information 33, transfer means information 34, worker information 35 including the information of delivering worker Wl, used material information 36, and floor layout information 37 (ST1: a first information acquisition step). Next, supply completion expected time calculator 27 calculates the delivering completion expected time and the supply completion expected time (ST2: an expected time calculation step).

Next, conveyance instruction creator 24 determines assigned unmanned transport vehicle V and creates conveyance instruction 43 including the traveling route and the stop position of unmanned transport vehicle V (transfer means) (ST3: a conveyance instruction creation step). Next, the conveyance instruction transmission unit (management-side communicator 48) transmits conveyance instruction 43 to unmanned transport vehicle V (ST4: a conveyance instruction transmission step). Unmanned transport vehicle V receiving conveyance instruction 43 moves to material storage cabinet S. Next, delivering instruction creator 22 determines assigned delivering worker Wl and picks up the material to be supplied to the manufacturing facility by delivering worker W1 from material storage cabinet S to create delivering instruction 41 for placing the material on unmanned transport vehicle V (ST5: a delivering instruction creation step). Next, the delivering instruction transmission means (transmission processing unit 30 and management-side communicator 48) transmits delivering instruction 41 to delivering worker W1 (ST6: a delivering instruction transmission step).

In FIG. 12, next, the delivering work remaining time transmission means (remaining time calculator 29 and management-side communicator 48) calculates the delivering work remaining time and transmits the information relating to the delivering work remaining time to the scheduled completion time of the delivering work to remaining time display unit 14 of unmanned transport vehicle V (ST7: a delivering work remaining time transmission step). Therefore, the delivering work remaining time is displayed on remaining time display unit 14 of unmanned transport vehicle V in which the delivering work is executed, and delivering worker W1 can know the delivering work remaining time remained for the delivering work. When the delivering work is completed, delivering worker W1 operates mobile terminal 4, button 15 of unmanned transport vehicle V, or the like, and reports the completion of the work to management computer 3. When the delivering work is completed, unmanned transport vehicle V moves to the manufacturing facility designated by conveyance instruction 43.

In FIG. 12, when the delivering work is completed, information acquisition unit 21 acquires worker information 35 including information of latest transfer means information 34 and supply worker Ws, and placing material information 38 (ST8: a second information acquisition step). Next, supply instruction creator 23 determines assigned supply worker Ws and picks up the material to be supplied to the manufacturing facility by supply worker Ws from unmanned transport vehicle V (transfer means) to create supply instruction 42 for supplying the material to the manufacturing facility (ST9: a supply instruction creation step). Next, the supply instruction transmitting means (transmission processing unit 30 and management-side communicator 48) transmits supply instruction 42 to supply worker Ws (ST10: a supply instruction transmission step).

Next, the supply work remaining time transmitting means (remaining time calculator 29 and management-side communicator 48) calculates the supply work remaining time and transmits the information relating to the supply work remaining time to the scheduled completion time of the supply work to remaining time display unit 14 of unmanned transport vehicle V (ST11: a supply work remaining time transmission step). Therefore, the supply work remaining time is displayed on remaining time display unit 14 of unmanned transport vehicle V in which the supply work is executed, and supply worker Ws can know the supply work remaining time (postponement time) remained for the supply work.

When the supply work is completed, supply worker Ws operates mobile terminal 4, button 15 of unmanned transport vehicle V, or the like, and reports the completion of the work to management computer 3. When the supply work is completed, unmanned transport vehicle V moves to the manufacturing facility that is the target of the next supply work designated by conveyance instruction 43. When unmanned transport vehicle V arrives at the manufacturing facility that is the target of the next supply work, the supply work remaining time in the manufacturing facility is displayed in remaining time display unit 14 of unmanned transport vehicle V. That is, the supply work remaining time is the postponement time of the supply work executed from the stop of unmanned transport vehicle V for the supply work to the start of movement toward the next stop position.

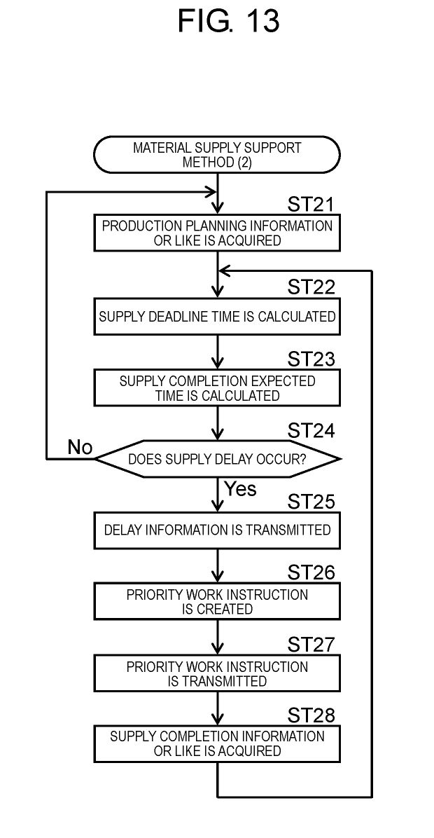

Next, another example of a material supply support method for supporting the supply work for supplying the material used in the manufacturing facility to the manufacturing facility will be described with reference to a flow of FIG. 13. In the other example, the conveyance of the material by unmanned transport vehicle V is the material supply executed in a case where the supply delay is predicted to occur. First, information acquisition unit 21 acquires production planning information 32, storage material information 33, transfer means information 34, worker information 35, used material information 36, and floor layout information 37 (ST21: a third information acquisition step). Next, supply deadline time calculator 26 calculates the supply deadline time that is a deadline for supplying the material to the manufacturing facility (ST22: a supply deadline time calculation step).

Next, supply completion expected time calculator 27 calculates the supply completion expected time for which delivering worker W1 picks up the material to be supplied to the manufacturing facility from material storage cabinet S and places the material on unmanned transport vehicle V (transfer means), unmanned transport vehicle V on which the material is placed moves to the manufacturing facility of the supply target, supply worker Ws picks up the material from stopped unmanned transport vehicle V to supply the material to the manufacturing facility to complete the supply work (ST23: a supply work completion expected time calculation step). Next, supply delay occurrence prediction unit 28 predicts whether or not the supply delay, in which the supply completion expected time exceeds the supply deadline time, occurs (ST24: supply delay occurrence prediction step).

In FIG. 13, in a case where it is predicted that the supply delay does not occur (No in ST24), the procedure proceeds to the third information acquisition step (ST21) and the latest information is acquired. When the occurrence of the supply delay is predicted (Yes in ST24), the delay information transmission means (transmission processing unit 30 and management-side communicator 48) transmits delay information 47 relating to the material for which the supply delay is predicted to administrator Wm (ST25: a delay information transmission step). Next, priority work instruction creator 25 determines allocated priority worker Wp and creates priority work instruction 44 for executing the priority work for picking up the material for which the supply delay is predicted from material storage cabinet S or unmanned transport vehicle V and supplying the material to the manufacturing facility with priority by priority worker Wp (ST26: a priority work instruction creation step).

Next, the priority work instruction transmission means (transmission processing unit 30 and management-side communicator 48) transmits priority work instruction 44 to priority worker Wp executing the priority work (ST27: a priority work instruction transmission step). When the priority work is completed, priority worker Wp operates mobile terminal 4 or the like, and reports the completion of the work to management computer 3. Next, information acquisition unit 21 acquires transfer means information 34, used material information 36, and supply completion information 39 (ST28: a fourth information acquisition step).

When information acquisition unit 21 acquires and updates transfer means information 34, used material information 36, and supply completion information 39, the process returns to the supply deadline time calculation step (ST22). That is, the supply deadline time and the supply completion expected time are recalculated (ST22 and ST23) and the occurrence of the supply delay is predicted again based on the supply deadline time and the supply completion expected time which are recalculated (ST24). Therefore, the occurrence of the supply delay is predicted based on the latest information.

As described above, manufacturing system 1 of the embodiment includes the manufacturing facility, material storage cabinet S for storing the material to be supplied to the manufacturing facility, and the transfer means (unmanned transport vehicle V) for placing the material and transporting the material to the manufacturing facility. The material supply support apparatus (management computer 3) has information acquisition unit 21 that acquires production planning information 32, storage material information 33, transfer means information 34, and worker information 35. Furthermore, the material supply support apparatus has delivering instruction creator 22 that creates delivering instruction 41 for picking up the material to be supplied to the manufacturing facility from material storage cabinet S and placing the material to the transfer means based on acquired information. Furthermore, the material supply support apparatus has the delivering instruction transmission means (transmission processing unit 30 and management-side communicator 48) for transmitting delivering instruction 41 to delivering worker Wl. Therefore, efficient material supply can be appropriately supported by the worker.

In the embodiments described above, delivering worker Wl executes the delivering work for which the material is picked up from material storage cabinet S and is placed on unmanned transport vehicle V (transfer means). However, in a case of floor F including an automatic material storage cabinet which automatically picks up the material, delivering instruction 41 may be transmitted to the automatic material storage cabinet. The automatic material storage cabinet receiving delivering instruction 41 sequentially picks up the materials in accordance with delivering instruction 41. In addition, the worker does not need to be a person, but it can be replaced by work means such as an articulated robot that can work in accordance with delivering instruction 41 and supply instruction 42.

According to the present disclosure, efficient material supply can be appropriately supported.

The material supply support apparatus and the material supply support method of the present disclosure have an effect of being able to appropriately support efficient material supply and are useful in the field of mounting the component on the board.

What is claimed is:

1. A material supply support apparatus comprising:
an information acquisition unit that acquires
production planning information including a scheduled usage number of a plurality of materials to be used in a manufacturing facility,
storage material information including the number of the materials stored in a material storage cabinet,
transfer means information including information for specifying transfer means for placing the materials and transporting the materials to the manufacturing facility, and
worker information including information for specifying a delivering worker who executes delivering work for which the materials are picked up from the material storage cabinet and placed on the transfer means;
a delivering instruction creator that creates a delivering instruction for picking up the materials to be supplied to the manufacturing facility from the material storage cabinet and placing the materials on the transfer means based on the production planning information, the storage material information, the transfer means information, and the worker information which are acquired by the information acquisition unit; and
a delivering instruction transmission unit that transmits the delivering instruction to the delivering worker.

2. The material supply support apparatus of claim 1,
wherein the information acquisition unit further acquires used material information including a remaining amount of materials used in the manufacturing facility.

3. The material supply support apparatus of claim 1,
wherein the delivering instruction creator creates the delivering instruction including an order in which the materials are picked up from the material storage cabinet.

4. The material supply support apparatus of claim 1,
wherein the information acquisition unit further acquires floor layout information including at least one of a disposition of the manufacturing facility, a disposition of the material storage cabinet, a traveling route of the transfer means, and a moving speed of the transfer means, and
wherein the delivering instruction creator creates the delivering instruction including an order in which the materials are placed on the transfer means based on information including the floor layout information acquired by the information acquisition unit.

5. The material supply support apparatus of claim 1, further comprising:
a delivering work remaining time transmission unit,
wherein the transfer means includes a remaining time display unit that displays a predetermined remaining time, and
wherein the delivering work remaining time transmission unit transmits information relating to a delivering work remaining time until a scheduled completion time of the delivering work to the remaining time display unit.

6. The material supply support apparatus of claim 1,
wherein the transfer means information includes an operation status of the transfer means, and
wherein the delivering instruction creator determines the transfer means for placing the materials from the operation status.

7. A material supply support method comprising:
acquiring
production planning information including a scheduled usage number of a plurality of materials to be used in a manufacturing facility,
storage material information including the number of the materials stored in a material storage cabinet,
transfer means information including information for specifying transfer means for placing the materials and transporting the materials to the manufacturing facility, and
worker information including information for specifying a delivering worker who executes delivering work for which the materials are picked up from the material storage cabinet and placed on the transfer means;
creating a delivering instruction for picking up the materials to be supplied to the manufacturing facility from the material storage cabinet and placing the materials on the transfer means based on the production planning information, the storage material information, the transfer means information, and the worker information; and
transmitting the delivering instruction to the delivering worker.

8. The material supply support method of claim 7, further comprising:
acquiring used material information including a remaining amount of materials used in the manufacturing facility.

9. The material supply support method of claim 7, further comprising:
creating the delivering instruction including an order in which the materials are picked up from the material storage cabinet.

10. The material supply support method of claim 7, further comprising:
acquiring floor layout information including at least one of a disposition of the manufacturing facility, a disposition of the material storage cabinet, a traveling route of the transfer means, and a moving speed of the transfer means; and
creating the delivering instruction including an order in which the materials are placed on the transfer means based on information including the floor layout information.

11. The material supply support method of claim 7, further comprising:
transmitting information relating to a delivering work remaining time until a scheduled completion time of the delivering work to a remaining time display unit,
wherein the transfer means has the remaining time display unit that displays a predetermined remaining time.

12. The material supply support method of claim 7,
wherein the transfer means information includes an operation status of the transfer means, and
wherein the transfer means for placing the materials is determined from the operation status.
